(19) United States
(12) Patent Application Publication
(10) Pub. No.: US 2003/0066809 A1
(43) Pub. Date: Apr. 10, 2003

(54) Effluent discharge system facilitates discharge of sediments, and powering of underwater machinery

(76) Inventor: Jerry Chi Wang, Paramus, NJ (US)

Correspondence Address: Jerry Chi Wang, 640 Cambridge Road, Paramus, NJ, 07652, US

(21) Appl. No.: 09/973,095

(22) Filed: Oct. 9, 2001

(51) Int. Cl. C02F 1/00

(52) U.S. Cl. 210/800

(57) ABSTRACT

The invention provides a means for discharging sediments by carrying them with the main water streams being released to the hydropower generators without the aid of any external supplied energy or pump and without wasting the useful potential energy of the water. The method of this invention can also be used for collecting valuable underwater mineral sediments from reservoirs or mountain lakes. With the addition of a fluid drive assembly, the effluent discharge system of this invention also facilitates powering of underwater dredging equipment or other underwater machinery for underwater work.

### FIELDS OF APPLICATIONS

The method and apparatus of this invention are most useful for discharging sediments in dammed or natural reservoirs where their influents often carry a large amount of sediments. It also provides a convenient means for powering underwater dredging equipment or other underwater machinery, and for collecting underwater mineral sediments.

### BACKGROUND

1. Technical Field

Reservoirs or dams that are built for primarily hydroelectric generation typically release the water through a gate at about the midlevel to ¾ way up of the normal operating water level. The water then flow down along a conduit or “penstock” to the electric generator. This mode of releasing water does not provide for the discharging of sediments that could build up in the reservoir bottom. The sedimentation problem is particularly critical for reservoirs or dams with influents carrying large amount of sediments. As years go by, the sediments would continue to build up and eventually could fill up the reservoirs rendering them useless in regulating water flow for flood control and for storing the water potential energy. Severe sedimentation is known to have caused some hydropower dams to loose their water storage capabilities. This invention provides a means to discharge reservoir bottom sediments using reservoir water's own hydrostatic head. Collection of underwater minerals from reservoir can also be made by the same method. It also facilitates powering of underwater machinery such as a dredging machine to dredge deep reservoir bottom.

2. Description of the Prior Art

No similar apparatus or effluent discharge system is known to have been installed in any hydropower dam or reservoir to facilitate discharging of bottom sediments or for powering underwater machinery, nor was there any patent found to have been issued for any similar apparatus for such purposes. For new dam constructions, there has been a proposal to install sluice gates at the base level of the dam to allow some small streams to carry some sediments away. Their effectiveness will be very limited, however, because of their relatively small flow quantities. Besides, all the water discharging through these low level gateways would be wasted in term of hydropower generation.

No patent was found either for any method or apparatus that can facilitate powering of underwater machinery or dredging machine, or for collecting valuable mineral sediments using the reservoir water's hydrostatic head

### SUMMARY

The invention provides a method for discharging reservoir bottom sediments/silt, facilitated by the effluent discharge system, by drawing the discharge water from the reservoir bottom at above fluidizing velocity to cause the sediments to be entrained and carried by the influent, and then forcing the slurry (sediments laden water) through the effluent discharge pipeline at high velocity to ensure their discharge on the downstream side of the reservoir. The effluent discharge system is essentially a pipeline comprising an intake port which is placed at or close to the reservoir bottom for drawing the discharge water and to suck up the sediments or silt; the connecting piping to transport the slurry from the pipeline intake through the reservoir reservoir from which the water/slurry is discharged. The system may include optional items such as a shut off valve, and flow and velocity measuring instruments for convenience. The connecting piping is sized and engineered to keep the anticipated slurry flow moving at velocity considerably above the slurry Critical Transport Velocity to assure its free passage without excessive pressure loss. The driving force for the task is made available by setting the elevation height of the discharge port according to the energy balance criteria described herein below and as summarized in mathematical terms in Equations 1 and 2. The novel method consumes only the pipeline friction loss for the task.

The following figures are presented as aids in illustrating the embodiments:

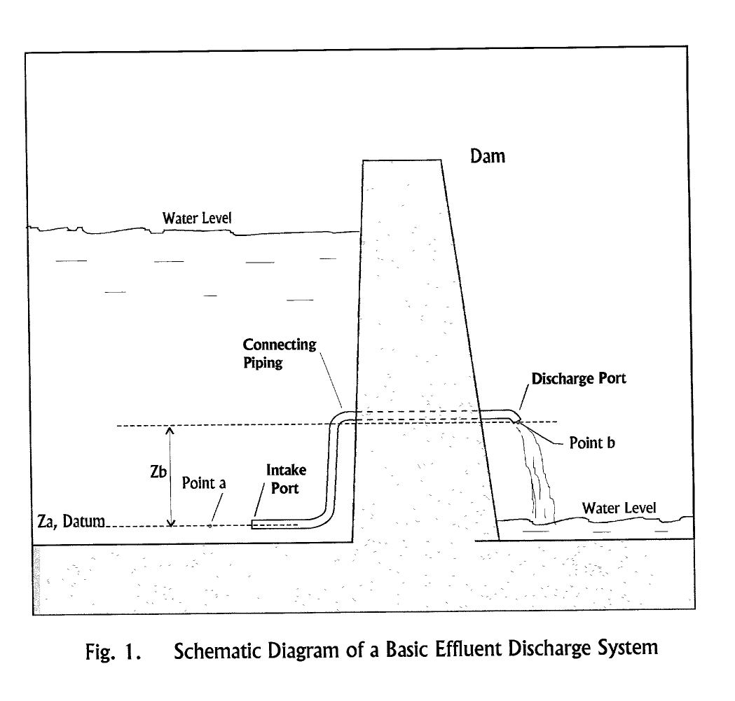

FIG. 1 is shown an example of a basic effluent discharge system.

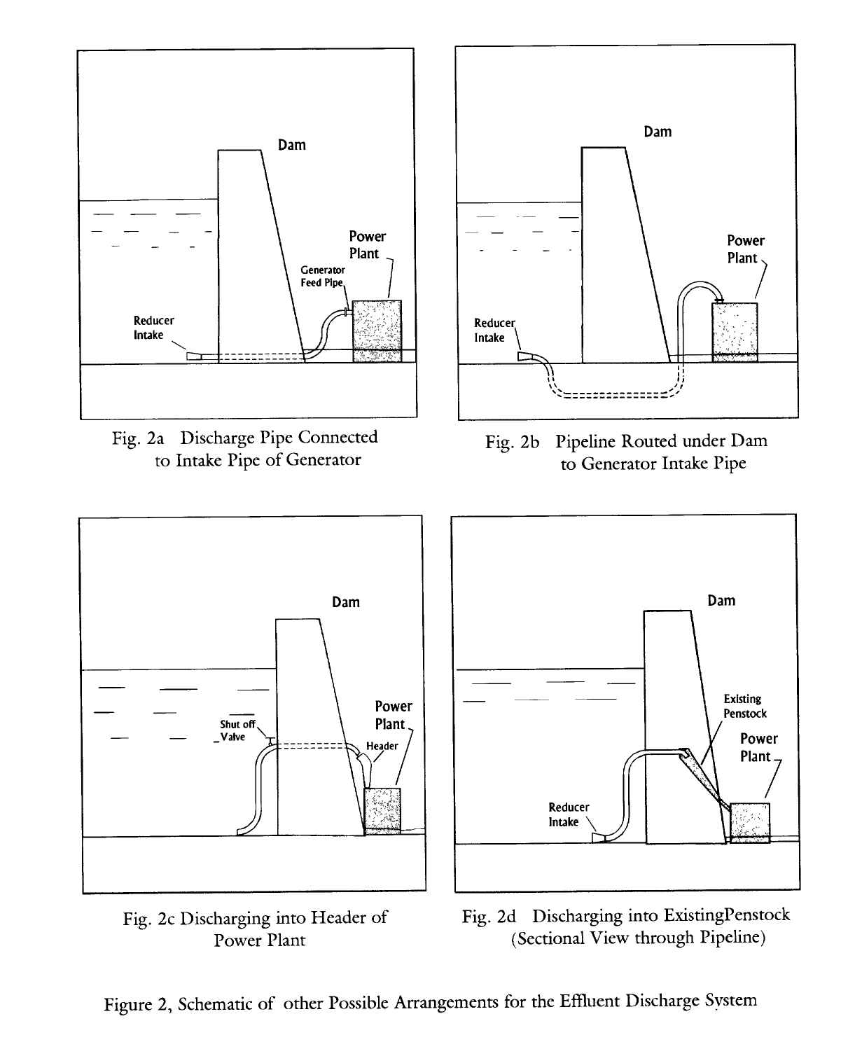

FIG. 2 shows four examples of other possible arrangements for the effluent discharge system.

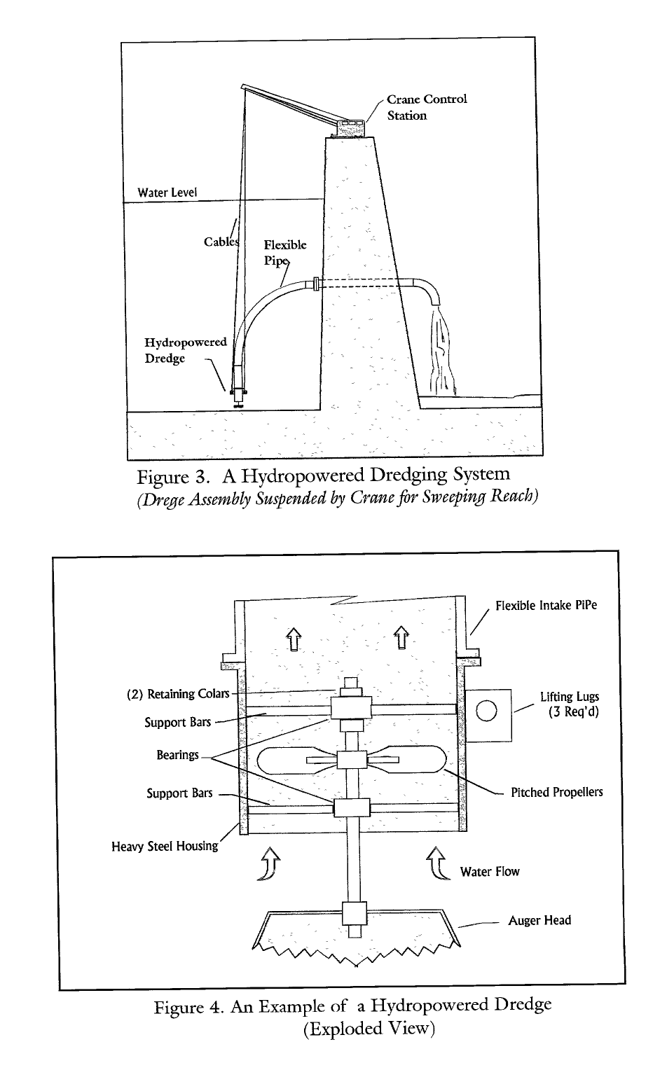

FIG. 3 shows an example of a dredging system powered by the reservoir's hydrostatic head.

FIG. 4 shows an example of the construction of a propeller driven dredging machine.

### DETAILED DESCRIPTION OF THE INVENTIONS

The dynamic working principle of the invention can be understood by examining the energy balance for an unit mass of the slurry at points of intake and at discharge for a basic system as shown in FIG. 1. The feasibility of transporting slurry through the engineered pipeline is supported by field data and with an understanding of the fluidization (entraining) of particles in moving fluids.

Solids particles become entrained in moving carrier fluid at fluid velocity above the Terminal Velocity of the particles, and the minimal velocity for transporting a slurry through a pipeline is known as the Critical Transport Velocity for that slurry and pipeline system. Some testing and field data have been available for estimating the Critical Transport Velocity and friction loss for transporting sandy sediments laden slurry through pipeline. For example, data showed that the Critical Transport Velocity for transporting a slurry containing 30% by weight of sands (average size 1600 microns) through a 12″ diameter Polypropylene pipe vertically is about 8 feet/sec and the pressure loss for same slurry system at 14.2′/sec velocity is 11.7′ water column per 100′ pipe. For 17.25″ diameter steel horizontal pipe transporting a phosphate slurry of small pebbles and fines at 15.5′/sec., the pressure loss is only 5.32′ water column per 100′ pipe, and the Critical Transport Velocity for same system is 8.2′/sec.

For a basic effluent discharge setup as shown in FIG. 1, a Bernoulli Equation may be written for the slurry at point a, just a short distance before entering the pipeline intake; and at point b, right at the discharge opening, as shown below: (Assuming the slurry is an incompressible fluid)

Pa/ρ+(g/g_{c})Za+Va²/2g_{c}=P_{b}/ρ+(g/g_{c})Z_{b}+V_{b}²/2g_{c}+H_{f} (Equation 1)

wherein above, P is the total pressure of the slurry at the designated location; subscripts a and b refer to the inlet and outlet stations; Z is the elevation height at the respective station; V is the average slurry velocity; H_{f} is the friction loss between point a and b (including the entrance loss)in height of slurry; ρ0 is the apparent density of the slurry; g is the acceleration of gravity; and g_{c}, the Newton's Law conversion factor.

Equation 1 may be simplified by assuming g equals to 32.174 ft/sec², the discharge port is open to the atmosphere, Za is at the reference datum elevation, and the velocity of intake slurry at point a is negligible (Va=0). As Pa is the sum of the atmospheric pressure (Patm) plus the water static head (Pₕₐ), and P_{b} equals to Patm (open discharge to the atmosphere), therefor Pa minus P_{b} equals to Pₕₐ. Equation 1 may then be simplified and rearranged to:

Z_{b}=Pₕₐ/ρ−V_{b}²/2g_{c}−H_{f} (Equation 2)

With a given satisfactory slurry transport velocity and pipeline pressure loss for an effluent discharge system, Equation 2 can be used readily to determine the highest allowable elevation height for the discharge port for an open air discharge system.

As the velocity head and the elevation head of the discharging slurry are readily recovered by the power generator, it becomes obvious that the only energy spent for discharging the slurry by this method is the friction loss through the pipeline. As the friction loss through the pipeline is directly related to the slurry solids content, normal operation can be expected to experience much less pressure loss than that calculated with the maximum possible solids concentration.

### EXAMPLE 1

A dam with an operating water level of 100 feet is to be installed with an effluent discharging system similar to that shown in FIG. 1 using 17.25″ diameter steel pipes. The maximum solids content of the bottom slurry is estimated to be about 35% by weight of sands and the slurry specific gravity is estimated at 1.3. Assuming a transport velocity of 12 feet/sec will be used and the total pipeline pressure loss, including the entrance loss, is 6 feet of slurry, what is the highest allowable discharge elevation height, relative to the intake, for the effluent discharge system?

The problem can be solved using Equation 2 by substituting the values of the known items (by consistent dimensional units) as shown below:

$${Z}_{b} ( ft ) = ( {100}^{′} \times 62.3 lb \text{/} c u . ft ) / ( 1.3 \times 62.3 lb \text{/} cu . ft ) - ( 12 ft \text{/} {sec}^{2} ) / ( 2 \times 32.174 lb \text{-} {sec}^{2} \text{/} ft \text{-} lb ) - 6 ft = {76.92}^{′} - {2.24}^{′} - 6 = {68.68}^{′} ( above the datum elevation )$$

Note that the allowable slurry discharge elevation height is based on slurry of density ρ. If the height were for water, it would be much higher by the inverse ratio of their respective densities.

The effluent discharge system can be used to power underwater machinery by installing a fluid drive assembly onto the intake pipe of the effluent discharge system. As an example, a propeller driven auger assembly (see FIG. 3 and FIG. 4) can be installed at the intake pipe end of the effluent discharge system to perform underwater dredging. The inflow water/slurry turns the propellers and the shaft, which in turn turns the auger head. The mechanics of the fluid drive is just the same as that for the hydroelectric generator. The real benefit is that the work can be performed under deep water otherwise not possible with the engine driven equipment, and the energy source is the readily available reservoir water's hydrostatic head. As the work done by the water/slurry is an output of the system, the shaft work is added to the right side of Equation 1. On account of this shaft work, Ws, Equation 2 would then be modified to

Z_{b}=Pₕₐ/ρ−V_{b}²/2g_{c}−H_{f}−Ws (Equation 3)

The shaft work done causes a reduction in the allowable discharge height. When the effluent discharge system is not concurrently used for discharging bottom sediments, the flow velocity restriction for slurry no longer applies. In such instances, slower transport velocity may be used to meet the energy requirement for the shaft work and for other considerations.

There are many other possible arrangements for the effluent discharge system than the basic arrangement as shown in FIG. 1. In general, the intake port, the discharge port, and the transport piping may be of any size or shape except to meet the transport fluid velocity requirements for the design flow rate. The pipeline may make turn in any direction, goes up or down, and of any length within the limit allowed by the available hydrostatic head and the pipeline friction loss considerations. The flow area of the transport piping may vary but the maximum cross sectional flow area at any point within the pipeline should not be larger than that to cause the slurry velocity to fall below the Critical Transport Velocity for the system. There is no velocity limitation when the effluent discharge system is used to handle clear water with minimal particulate matters. The intake pipe may even be an underground tunnel with opening to reservoir bottom, and the transport pipeline may also be a tunnel or built-in channels within the dam. The intake port may simply be the open end of the intake pipe or a reducer with the smaller end connected to the intake pipe. The discharge port may simply be an open pipe end or an elbow's end. In the case of direct connection to the generator feed pipe, one may consider the connecting pipe join as the discharge port.

In FIG. 2 are shown four examples of other possible arrangements for the effluent discharge system. Instead of open air discharge as shown in FIG. 1, the slurry discharge pipe may be routed to discharge into the dam's existing penstock, a large vertical or steep down-flow feed pipe header for the generators, or be directly connected to the feed pipe of the generator. In the latter case, the available hydrostatic head of the water becomes the pressure head of the discharging effluent suitable for the high or medium head type hydro-generators uses. The penstock or the larger down flow pipe header to the generator may be considerably larger than the slurry transport pipe as long as their downward angle is more than 45 degrees such that the slurry would continue to accelerate. The same principle applies to the final down flow section of the slurry discharge pipe.

Preferably, the intake port is of a reducer shape to minimize entrance loss, and the effluent discharge system is constructed with pipes of uniform diameter having smooth inside surfaces and of abrasion resistant materials with minimum number of turns. The pipeline is sized to give the slurry flow velocity at 30% or more over the slurry Critical Transport Velocity. All turns preferably are of long radius type and the total length of the pipeline is kept to minimal to minimize the pipeline friction loss. Minimizing the elevation height of the over all system will extend the reservoir's useful storage capacity.

What I claim as my inventions are:

1. The apparatus or the effluent discharge system comprising at least the basic elements of an intake port, which is located at or close to the reservoir bottom; a discharge port, located on the downstream side of the reservoir; and the connecting piping between the intake and discharge for transport the sediments laden influent from the intake through the reservoir boundary barrier to the discharge; whereas the elevation height of the discharge port of the system, relative to the intake, is set at or below the highest allowable elevation height that suffices to develop adequate pressure differential between the system's intake and discharge to cause the influent flow to entrain and pick up sediments/silt, to carry them through the system pipeline, and to discharge them on the down stream side of the reservoir for the purposes of preserving or increasing the reservoir's usable water storage capacity, for collecting valuable sediments, or for other useful purposes.

2. The method of discharging reservoir sediments, facilitated with the use of the apparatus of claim No. 1 above, by drawing the discharge water and/or slurry from the reservoir bottom or close to the bottom at fluidizing velocity to cause the sediments/silt to be entrained and picked up by the influent flow, and then forcing the sediments laden water through the apparatus's pipeline to discharge them on the downstream side of the reservoir; wherein the driving force for the task is primarily drawn from the reservoir water's hydrostatic head by setting the elevation height of the apparatus's discharge at or below that suffices to develop adequate pressure differential between the apparatus's intake and discharge to provide the driving force, with or without any additional external supplied energy or pump as supplement.

3. The method of powering underwater machinery by installing suitable fluid drive assembly onto the intake pipe of the effluent discharge system of claim No. 1 above with the added load for powering the machinery, or by installing suitable fluid drive assembly onto other apparatus similarly constructed but is engineered primarily to develop sufficient pressure differential and water flow velocity for powering the machinery, with or without the requirement for discharging sediments.
